(19) United States
(12) Patent Application Publication
(10) Pub. No.: US 2007/0040337 A1
(43) Pub. Date: Feb. 22, 2007

(54) Sealing structure for the mouth of a high vacuum knife

(75) Inventor: Ming-Tien Wu, Tainan City (TW)

Correspondence Address: LEONG C LEI, PMB # 1008, 1867 YGNACIO VALLEY ROAD, WALNUT CREEK, CA, 94598, US

(73) Assignee: HIGHLIGHT TECH CORP.

(21) Appl. No.: 11/204,361

(22) Filed: Aug. 16, 2005

(51) Int. Cl. F16L 21/02

(52) U.S. Cl. 277/616

(57) ABSTRACT

A sealing structure for the mouth of a high vacuum knife is disclosed. The sealing structures comprises a top and a bottom knife and the center of the knife being hollow, characterized in that the edge of the knife has recessed structure provided with at least three biting section as a biting section such that the fabricating gasket is bitten to form into a multiple seals at the vacuum side.

### BACKGROUND OF THE INVENTION

(a) Technical Field of the Invention

The present invention relates to sealing structure for the mouth of a high vacuum knife, and in particular, a sealing structure which enhances the sealing of the surface of a fabrication gasket.

(b) Description of the Prior Art

FIGS. 1 to 7 depict conventional sealing knife. The sealing knife 1 has a hollow interior and the surface of the inner edge of the sealing knife 1 has a protruded biting section 11, which has teething structure. This conventional sealing knife 1 is provided with only one biting section 11 to allow sealing of a fabrication piece, and if any edge at the biting section 11 is damaged. The bitted gasket 2 will not function to isolate the atmospheric region and the vacuum region. Thus, the sealing knife can no longer be used unless a new knife 1 is replaced.

Referring to FIGS. 4, 5, 6 and 7, the operation of the processing knife 1 is very complicated and the cost of the knife is high. Accordingly, it is an object of the present invention to provide a sealing structure of a sealing knife which overcomes the above drawbacks.

### SUMMARY OF THE INVENTION

The primary purpose of the present invention is to provide a sealing structure for the mouth of a high vacuum knife comprising a top and a bottom knife and the center of the knife being hollow, characterized in that the edge of the knife has recessed structure provided with at least three biting section as a biting section such that the fabricating gasket is bitten to form into a multiple seals at the vacuum side.

Another object of the present invention is to provide a sealing structure for the mouth of a high vacuum knife.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a conventional sealing knife.

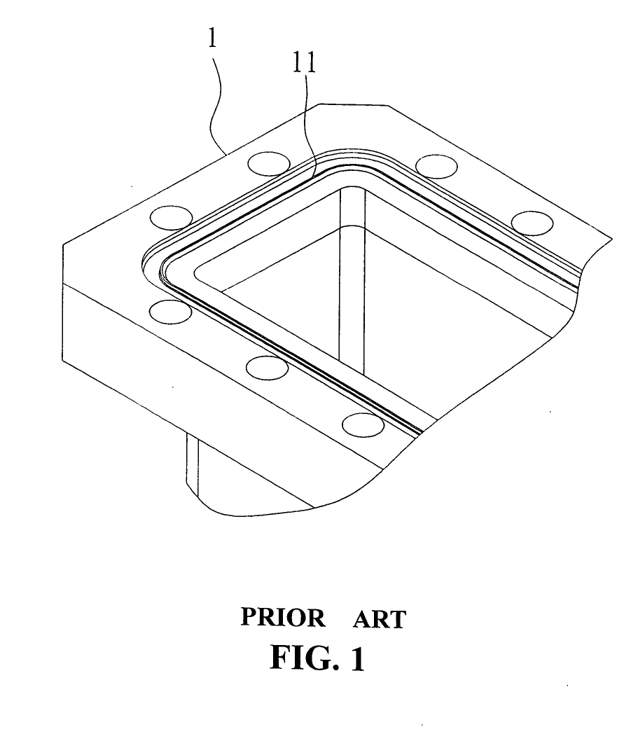

FIG. 2 is a sectional view showing the biting function of the gasket of the conventional sealing knife.

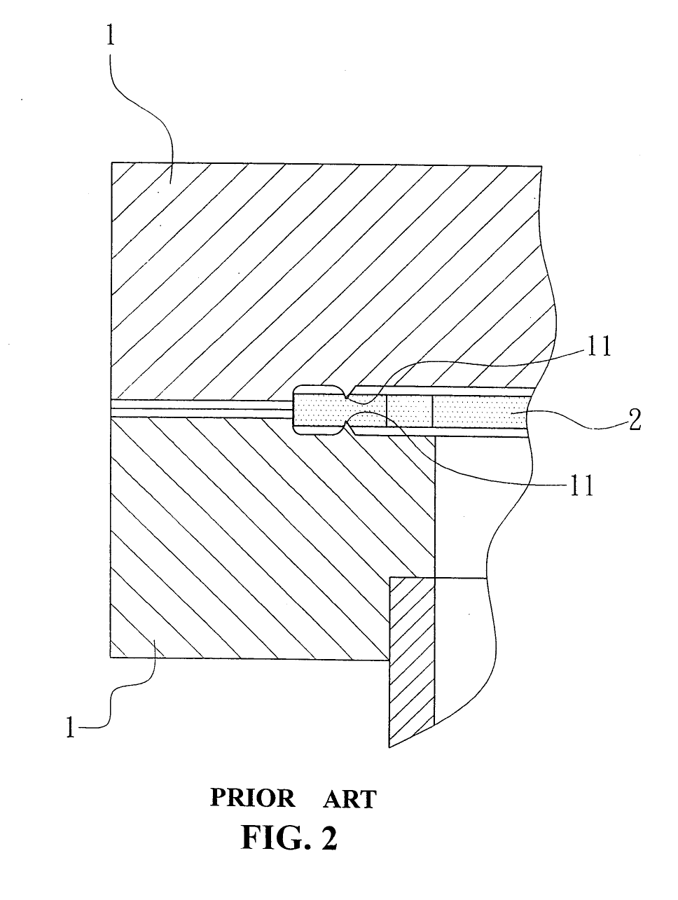

FIG. 3 is an enlarge view of the knife section of the conventional sealing knife.

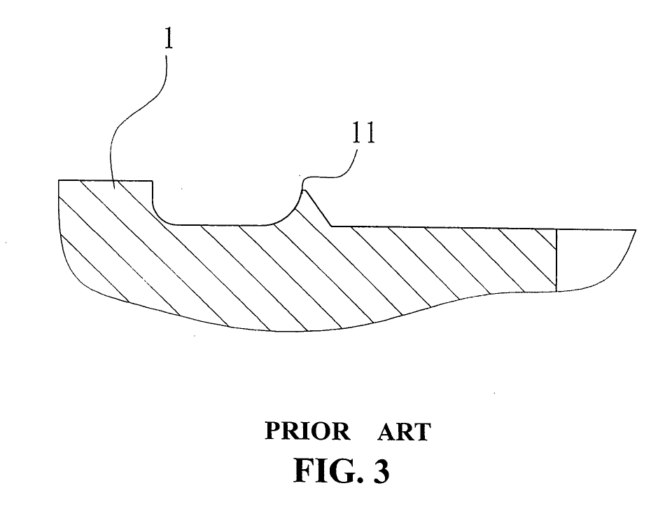

FIGS. 4 to 7 are views showing the processing of the fabricating knife with the conventional sealing knife.

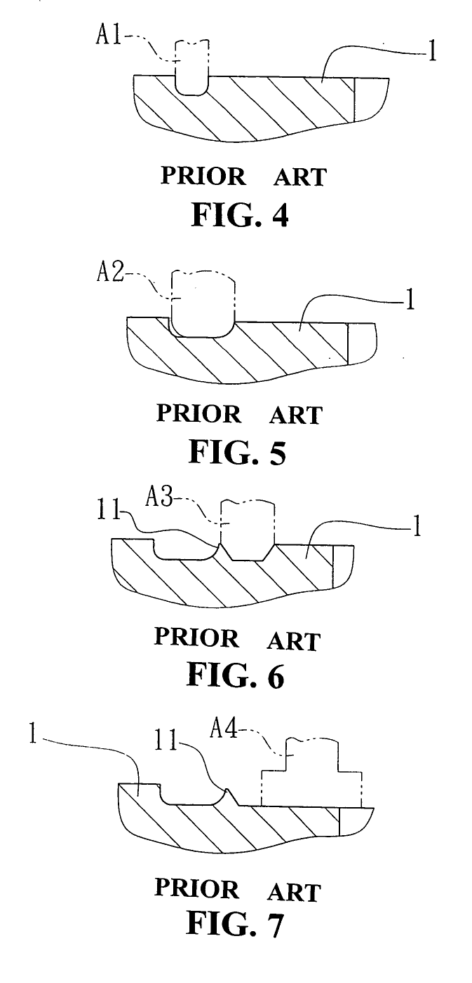

FIG. 8 is a perspective view of the sealing knife of the present invention.

FIG. 9 is a sectional view showing the biting of gasket by the sealing knife of the present invention.

FIG. 10 is an enlarge view of the knife section in accordance with the present invention.

FIG. 11 to 13 are schematic view showing the processing of the working knife and the knife of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

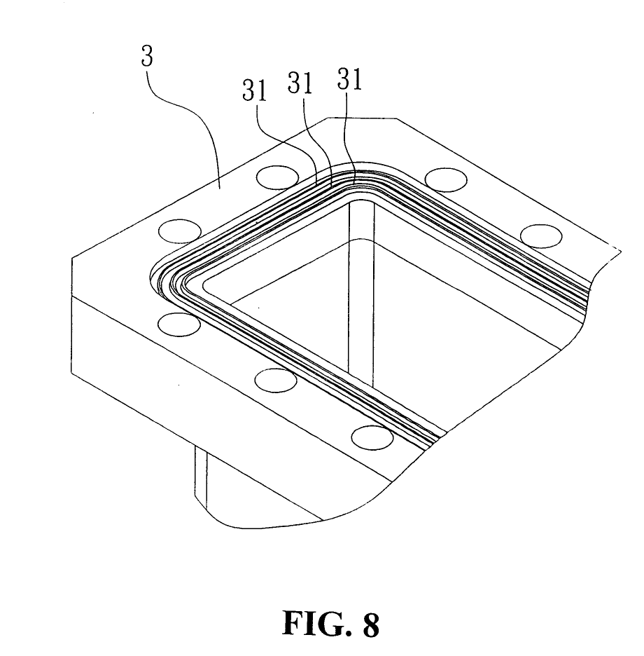

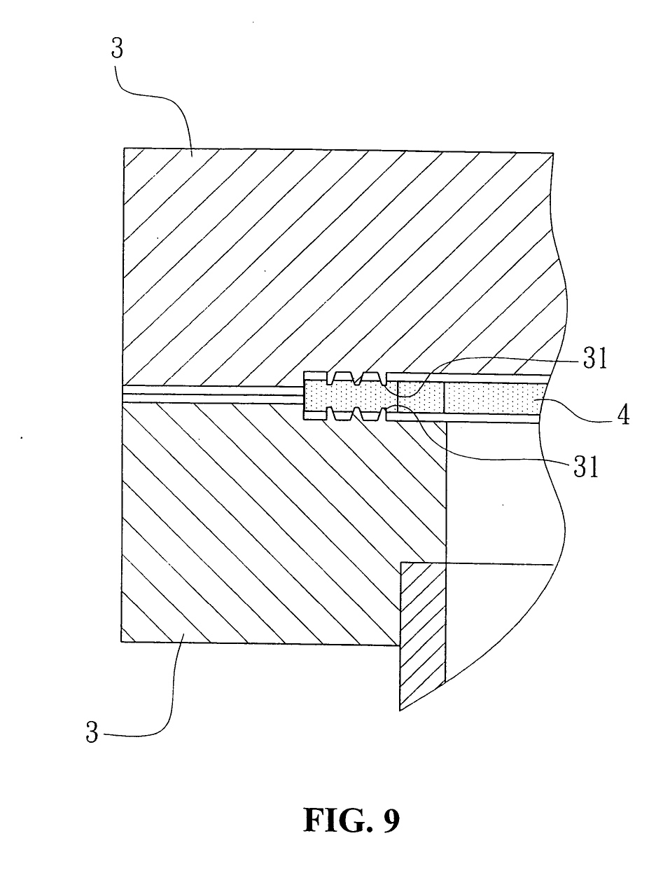

Referring to FIGS. 8 to 13, there are shown views of the sealing structure of a high vacuum knife in accordance with present invention.

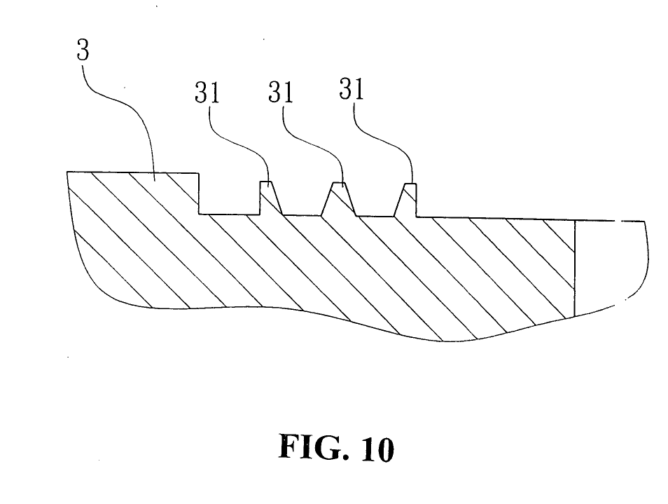

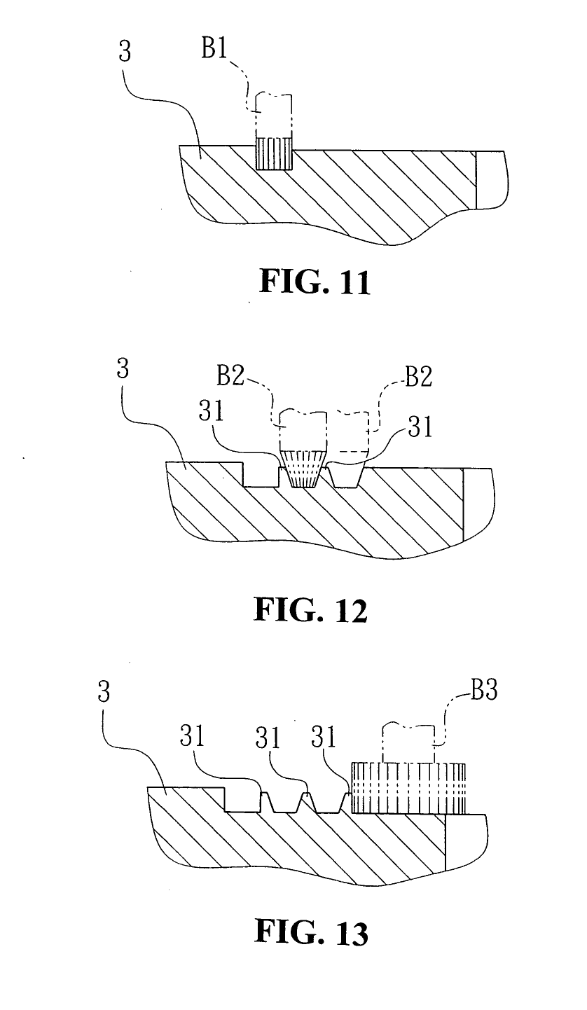

In accordance with the present invention, the sealing structure comprises a top and bottom knife 3, and the knife 3 is a hollow structure and the edge of the knife 3 includes at least three protruded sections, forming into biting sections 31 (as shown in FIGS. 8 and 10) with a plurality of mouths. If the structure is to be used for fabrication copper gasket 4, the copper gasket 4 is placed onto the center of the top and bottom knife 8, and the biting section 31 bites the edge of the copper gasket 4 such that the external edge of the biting section 31 of the knife mouth and the depressed path are formed into an atmospheric side, and the multiple sealed layers at the inner side of the multiple knife mouths are formed into the vacuum side. Boyle's law is applicable to this structure, i.e., pressure decreases as volume increases. This provides the gasket 4 with high vacuum dustproof sealed environment. When one of the biting section 31 is damaged, other biting section are still in good condition and therefore, this will provide multiple layer of isolation. Accordingly, the longevity of the device is thus prolonged. In accordance with the present invention, the knife 3 includes a top and two blocks and has a recessed structure such that when the knife 3 is sealed with the gasket 4, only a section of the knife 3 is inserted, and in the fabrication process, as shown in FIGS. 11, 12 and 13, the working knife B1 lathes downwardly, as shown in FIG. 11, and a conic knife B2 continuous lathes out two adjacent section to form into biting section 31, as shown in FIG. 12. Finally the lathe knife of the working knife B3 lathe at the center region, as shown in FIG. 13. Due to the fact that the quantity of knife for processing is larger, therefore, the working knife B1, B2, B3, B4 can be fabricated in one fabrication process. If the biting section 31 is damaged, the other biting sections 31 are still workable.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A sealing structure for the mouth of a high vacuum knife comprising a top and a bottom knife and the center of the knife being hollow, characterized in that the edge of the knife has recessed structure provided with at least three biting section as a biting section such that the fabricating gasket is bitten to form into a multiple seals at the vacuum side.

2. The sealing structure of claim 1, wherein the biting section is sealed by the sealing method of Boyle's law.
